(19) United States
(12) Patent Application Publication
(10) Pub. No.: US 2021/0324982 A1
(43) Pub. Date: Oct. 21, 2021

(54) CLAMP LOCATING SYSTEM AND METHOD

(71) Applicant: Ideal Clamp Products, Inc., Smyrna, TN (US)

(72) Inventor: Edwin T. KOEHLER, Smyrna, TN (US)

(21) Appl. No.: 17/265,127

(22) PCT Filed: Aug. 14, 2019
(86) PCT No.: PCT/US2019/046474

§ 371 Date: Feb. 1, 2021

Related U.S. Application Data
(60) Provisional application No. 62/718,668, filed on Aug. 14, 2018.

(51) Int. Cl. F16L 23/08

(52) U.S. Cl. CPC F16L 23/08

(57) ABSTRACT

A band clamp includes a band including an inner surface facing toward a central axis and a groove defined in the inner surface. The band has a central section and a pair of side sections coupled to the central section. A bracket including an elongated strip is positioned in the groove of the central section. A system and method utilizing the band clamp are also contemplated.

### CROSS-REFERENCE TO RELATED APPLICATIONS

This application is a Patent Cooperation Treaty application of, and claim priority to, U.S. Patent Ser. No. 62/718,668, filed Aug. 14, 2018, which is hereby incorporated by reference.

### TECHNICAL FIELD

The present disclosure relates to clamp designs and, more specifically, to a design for a clamp for a joint.

### BACKGROUND

Clamps are commonly utilized to join together exhaust hoses and fittings or connectors, for example, within the automotive industry. Hose clamps may include a liner that may be spot welded, riveted, or otherwise fastened to a circular outer band and a locking mechanism to couple the ends of the outer band together and apply tension to the clamp. One type of exhaust clamp is a band clamp, which typically includes at least one inner segment contained by a circular outer band. The outer band includes a tensioning mechanism to apply tension to the band when tightened that in turn applies a radial pressure to the inner segment. The inner segment converts most of the radial pressure in the joint formed between a pair of conduits to axial pressure on the joint, while still maintaining a smaller radial pressure on the joint. Additionally, some variants of band clamps are designed to allow for a small axial misalignment between the conduits forming the joint, for example, when the joint includes a full marmon on one conduit and a flared end on the other conduit.

Band clamps are generally designed to accommodate for either axial misalignment or near equal distribution of radial versus axial pressure on the joint. When accommodating for axial misalignment, many of these band clamps rely on radial pressure to prevent the joint from pulling apart, i.e. the clamp does not provide for both radial and axial sealing pressure. Radial pressure is achieved by providing slots in the outer conduit that enable the outer conduit to deform and crush on the inner conduit. Such slots frequently enable potential leaks in the joint. Other known clamps require spot welding to seal the joint.

### SUMMARY

According to an aspect of the disclosed embodiments, a system may include a band clamp having a band including an inner surface facing toward a central axis and a groove defined in the inner surface. The band clamp may also include a bracket including an elongated strip positioned in the groove and a pair of feet positioned inward of the elongated strip closer to the central axis. A conduit may include a substantially cylindrical body having an axis. A flared flange may extend radially outwardly from the cylindrical body. The pair of feet may be secured to the flared flange such that the band is spaced apart from the flared flange.

In some embodiments, the elongated strip may be secured within the groove. The elongated strip may be at least one of fastened or welded into the groove. Each of the pair of feet may be cantilevered from an end of the elongated strip. The elongated strip may include a plurality of elongated strips. Each of the plurality of elongated strips may have a pair of feet positioned inward of the respective elongated strip closer to the central axis.

Optionally, the band may include a center section and a pair of side sections coupled to the central section. The bracket may be secured to the center section. The side sections may be hingedly attached to the center section. A tensioning mechanism may be configured to secure the side sections to one another. The tensioning mechanism may include a fastener. Each of the pair of feet may be welded to the flared flange.

According to another aspect of the disclosed embodiments, a band clamp may include a band including an inner surface facing toward a central axis and a groove defined in the inner surface. The band may have a central section and a pair of side sections coupled to the central section. The band clamp may also include a bracket including an elongated strip positioned in the groove of the central section and a pair of feet positioned inward of the elongated strip closer to the central axis. Each of the pair of feet may be cantilevered from an end of the elongated strip.

It may be contemplated that the elongated strip is secured within the groove. The elongated strip may be at least one of fastened or welded into the groove. The elongated strip may include a plurality of elongated strips. Each of the plurality of elongated strips may have a pair of feet positioned inward of the respective elongated strip closer to the central axis.

It may be desired that the side sections are hingedly attached to the center section. A tensioning mechanism may be configured to secure the side sections to one another. The tensioning mechanism may include a fastener.

According to yet another aspect of the disclosed embodiments, method of securing a band clamp to a conduit is provided. The a band clamp may include a band including an inner surface facing toward a central axis and a groove defined in the inner surface. The band clamp may also include a bracket including an elongated strip positioned in the groove and a pair of feet positioned inward of the elongated strip closer to the central axis. The method may include positioning a band of the band clamp over the conduit so that at least one of the pair of feet contacts a flange of the conduit. The method may also include positioning the band clamp so that a gap is formed between the band and the flange of the conduit. The method may also include securing the at least one of the pair of feet to the flange of the conduit.

In some embodiments, securing the at least one of the pair of feet to the flange of the conduit further comprises welding the at least one of the pair of feet to the flange of the conduit. The method may also include securing each of the pair of feet to the flange of the conduit. Securing each of the pair of feet to the flange of the conduit may also include welding each of the pair of feet to the flange of the conduit.

### BRIEF DESCRIPTION OF THE DRAWINGS

The foregoing and other features of the various embodiments of the methods and apparatuses described herein will become more apparent from the following detailed description and the accompanying drawings in which:

FIG. 1 is a perspective view of a band clamp;

FIG. 2 is another perspective view of the band clamp of FIG. 1;

FIG. 3 is a cross-sectional view of the band clamp taken along the line 3-3 in FIG. 2;

FIG. 4 is a perspective view of a male conduit, a corresponding female conduit, and the band clamp of FIG. 1;

FIG. 5 is a cross-sectional view of the male conduit and the band clamp taken along the line 5-5 in FIG. 4;

FIG. 6 is a perspective view of the conduits of FIG. 4 assembled with the band clamp before the band clamp is tightened;

FIG. 7 is a cross-sectional view of the conduits and the band clamp taken along the line 7-7 in FIG. 6; and

FIG. 8 is a perspective cross-sectional view of the conduits and the band clamp of FIG. 6 after the band clamp is tightened.

### DETAILED DESCRIPTION OF THE DRAWINGS

While the concepts of the present disclosure are susceptible to various modifications and alternative forms, specific exemplary embodiments thereof have been illustrated by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

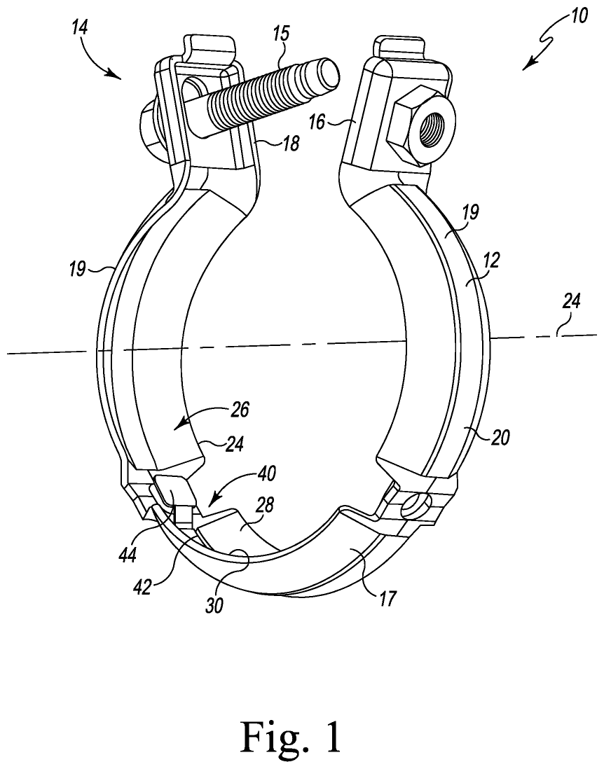

Referring now to FIG. 1, a band clamp 10 is shown. The band clamp 10 includes a band 12 having a tensioning mechanism 14 coupled thereto. The band 12 has a first end 16 and a second end 18 that are configured to be joined by the tensioning mechanism 14. In the illustrative embodiment, the tensioning mechanism 14 includes a fastener 15. The band 12 includes a center section 17 and a pair of side sections 19 hingedly extending from the center section 17. The side sections 19 includes the first end 16 and the second end 18. The side sections 19 are configured to be joined by the fastener 15.

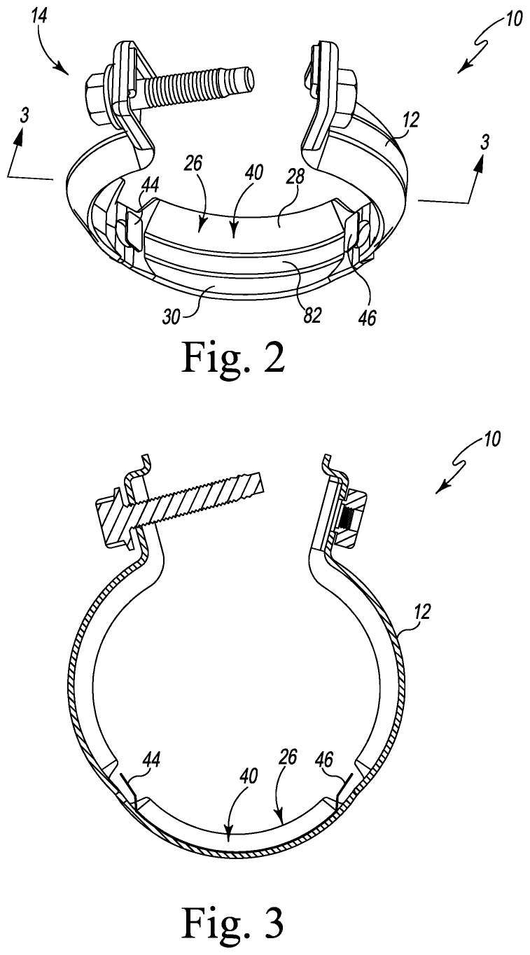

The band 12 includes an outer surface 20 and an inner surface 22 that extend around the central axis 24 of the band clamp 10. In the illustrative embodiment, the band 12 has an annular groove 26 that is defined in the inner surface 22 by a pair of side walls 28, 30. As shown in FIGS. 1-2, the groove 26 has a cross-sectional profile that is V-shaped, or alternatively C-shaped.

The band clamp 10 includes a bracket 40 that is positioned in the groove 26. In the illustrative embodiment, the bracket 40 is positioned in the center section 17 of the band 12. As shown in FIG. 3, the bracket 40 includes an elongated strip 42 and a pair of feet 44, 46 that extend inwardly from respective ends of the elongated strip 42. In the illustrative embodiment, the feet 44, 46 are cantilevered form ends of the elongated strip 42. In the illustrative embodiment, the band 12 and the bracket 40 are formed from metallic materials. The bracket 40 may be spot welded to the band 12 within the groove 26. It should be appreciated that in other embodiments the bracket 40 may be secured to the band 12 via mechanical fasteners such as screws or rivets, may be secured to the band via a press fit, or through the use of some other fastening means. It should also be appreciated that in other embodiments the bracket 40 may include multiple strips and each strip may include one or more feet.

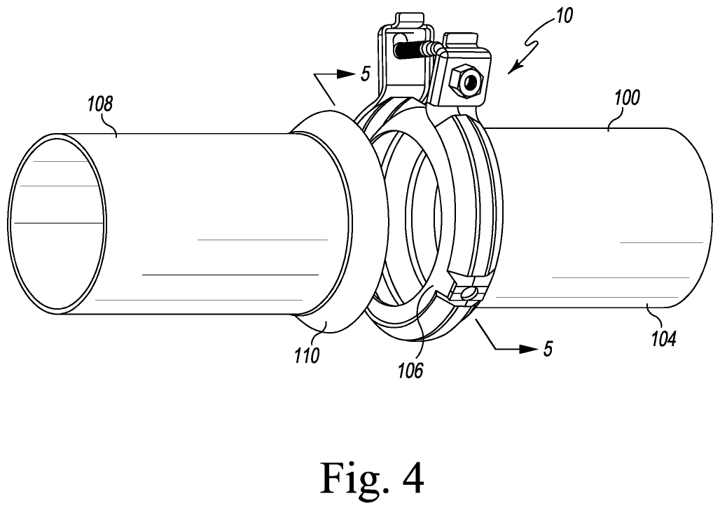

Referring now to FIG. 4, the band clamp 10 may be positioned on a male exhaust conduit 100 to form an assembly 102. In the illustrative embodiment, the assembly 102 is configured for use in a joint of an automotive exhaust system. It should be appreciated that in other embodiments the assembly 102 may be configured for use in other joints in other automotive or commercial applications. The male exhaust conduit 100 has a cylindrical body 104 and a flared flange 106 that may be coupled to another component of the exhaust system, such as, for example a female conduit 108 to form a joint. As described in greater detail below, the band clamp 10 is secured to the male exhaust conduit 100 such that the band clamp 10 is maintained in position to properly secure the conduits 100, 108 together. It should be appreciated that in other embodiments the clamp may be secured to a female exhaust conduit.

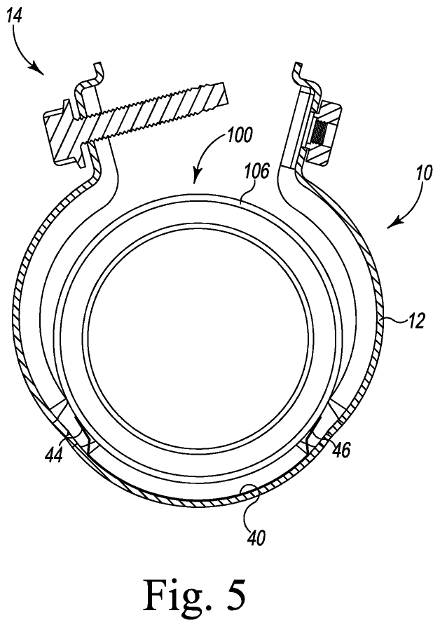

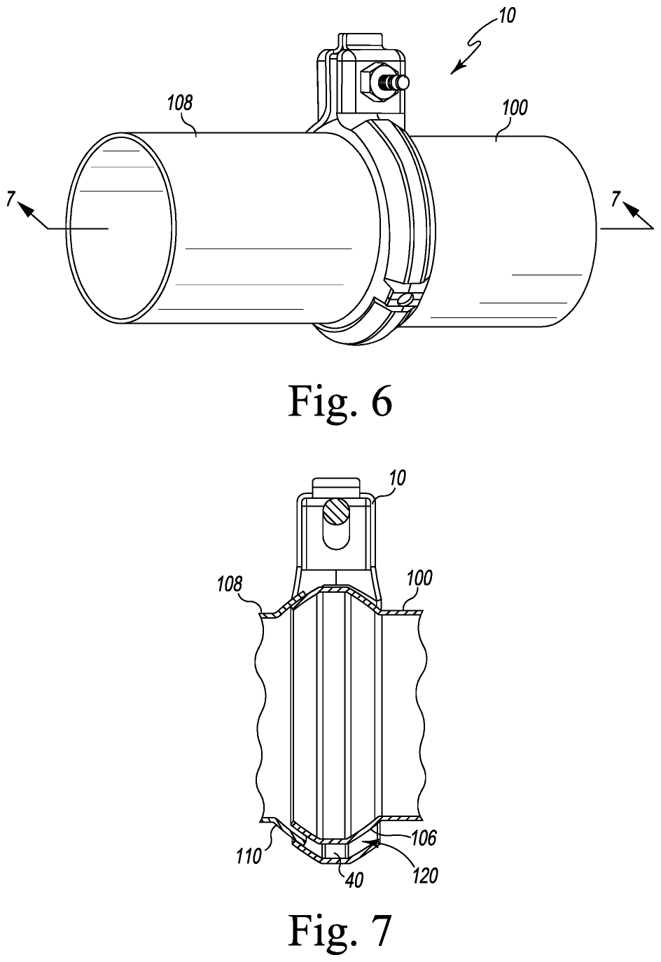

As shown in FIG. 5, each of the feet 44, 46 of the band clamp 10 contacts the flared flange 106 of the conduit 100 such that the band 12 and the rest of the band clamp 10 is offset from the joint (e.g., the flanged flange 106). The bracket 40 may be spot welded to the flared flange 106 to retain the clamp 10 on the male exhaust conduit 100. It should be appreciated that in other embodiments the bracket 40 may be secured to the conduit 100 via mechanical fasteners such as screws or rivets, may be secured to the band via a press fit, or through the use of some other fastening means.

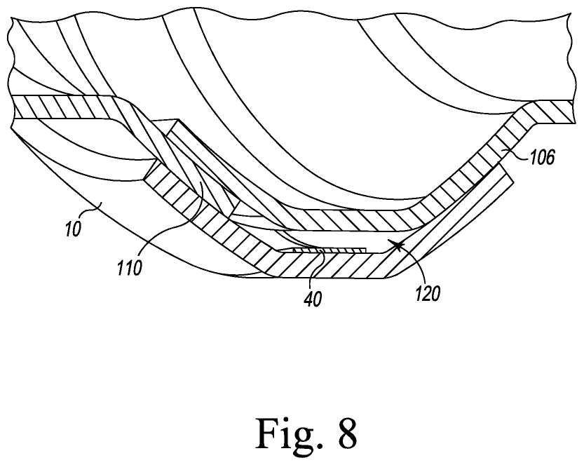

During assembly, the flared flange 110 of the female conduit 108 may be placed in the space between the clamp 10 and the flared flange 106. Once the female flared flange 110 is placed in the space between the clamp 10 and the flared flange 106, the clamp 10 acts as a detent to hold the female conduit 108 is place. With the joint components and the clamp are in place, the clamp 10 may be tightened. The feet 44, 46 flex with the increased tension so as to not impede clamp movement as the clamp 10 is tightened. As shown in FIGS. 7-8, the elongated strip 42 of the bracket 40 is positioned in an air gap 120 within the groove 26 spaced apart from the flared flanges 106, 110 and does not affect the clamp performance.

It will be appreciated that the devices and methods described herein have broad applications. The foregoing embodiments were chosen and described in order to illustrate principles of the methods and apparatuses as well as some practical applications. The preceding description enables others skilled in the art to utilize methods and apparatuses in various embodiments and with various modifications as are suited to the particular use contemplated. In accordance with the provisions of the patent statutes, the principles and modes of operation of this disclosure have been explained and illustrated in exemplary embodiments.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

1. A system comprising:
a band clamp comprising (i) a band including an inner surface facing toward a central axis and a groove defined in the inner surface, and (ii) a bracket including an elongated strip positioned in the groove and a pair of feet positioned inward of the elongated strip closer to the central axis, and
a conduit comprising (i) a substantially cylindrical body having an axis, and (ii) a flared flange extending radially outwardly from the cylindrical body, wherein the pair of feet are secured to the flared flange such that the band is spaced apart from the flared flange.

2. The system of claim 1, wherein the elongated strip is secured within the groove.

3. The system of claim 1, wherein the elongated strip is at least one of fastened or welded into the groove.

4. The system of claim 1, wherein each of the pair of feet is cantilevered from an end of the elongated strip.

5. The system of claim 1, wherein the elongated strip extends only partway around the central axis.

6. The system of claim 1, wherein the band includes a center section and a pair of side sections coupled to the central section, wherein the bracket is secured to the center section.

7. The system of claim 6, wherein the side sections are hingedly attached to the center section.

8. The system of claim 6, wherein a tensioning mechanism is configured to secure the side sections to one another.

9. The system of claim 8, wherein the tensioning mechanism includes a fastener.

10. The system of claim 1, wherein each of the pair of feet is welded to the flared flange.

11. A band clamp comprising:
a band including an inner surface facing toward a central axis and a groove defined in the inner surface, the band having a central section and a pair of side sections coupled to the central section, and
a bracket including an elongated strip positioned in the groove of the central section and a pair of feet positioned inward of the elongated strip closer to the central axis, wherein each foot of the pair of feet is cantilevered from a circumferential end of the elongated strip relative to the central axis.

12. The band clamp of claim 11, wherein the elongated strip is secured within the groove.

13. The band clamp of claim 11, wherein the elongated strip is at least one of fastened or welded into the groove.

14. (canceled)

15. The band clamp of claim 11, wherein the side sections are hingedly attached to the center section.

16. The band clamp of claim 11, wherein a tensioning mechanism is configured to secure the side sections to one another.

17. The band clamp of claim 16, wherein the tensioning mechanism includes a fastener.

18. A method of securing a band clamp to a conduit, wherein the band clamp includes (i) a band including an inner surface facing toward a central axis and a groove defined in the inner surface, and (ii) a bracket including an elongated strip positioned in the groove and a pair of feet positioned inward of the elongated strip closer to the central axis, the method comprising:
positioning a band of the band clamp over the conduit so that at least one of the pair of feet contacts a flange of the conduit and a gap is formed between the band and the flange of the conduit,
securing the at least one of the pair of feet to the flange of the conduit, and
tightening the band clamp around the flared flange of the conduit after securing the at least one of the pair of feet to the flange of the conduit.

19. The method of claim 18, wherein securing the at least one of the pair of feet to the flange of the conduit further comprises welding the at least one of the pair of feet to the flange of the conduit.

20. The method of claim 18, further comprising securing each of the pair of feet to the flange of the conduit.

21. The method of claim 20, wherein securing each of the pair of feet to the flange of the conduit further comprises welding each of the pair of feet to the flange of the conduit.
